(19) United States
(12) Patent Application Publication
(10) Pub. No.: US 2025/0238746 A1
(43) Pub. Date: Jul. 24, 2025

(54) ASYNCHRONOUS ARTIFICIAL INTELLIGENCE SYSTEM

(71) Applicant: Nrby, Inc., Manchester, NH (US)

(72) Inventors: Iassen Bojilov, Sofia (BG); Jeremy Breau, Kansas City, MO (US)

(21) Appl. No.: 19/032,095

(22) Filed: Jan. 19, 2025

Related U.S. Application Data
(60) Provisional application No. 63/623,173, filed on Jan. 19, 2024.

(51) Int. Cl. G06Q 10/0635; G06N 20/00

(52) U.S. Cl. CPC G06Q 10/0635; G06N 20/00

(57) ABSTRACT

An asynchronous artificial intelligence (AAI) system that is configured to receive internal data associated with a customer of the AAI system, wherein the customer is a service provider; search, in an ongoing manner, one or more external data sources that are external from the customer to obtain external data; and send machine learning output to the customer that presents a proposal of a customer action to address a predicted service degradation of the service provider based on the input of the internal data and the external data to an AI or machine learning (AI/ML) model that is trained based on historical data of the customer.

### CROSS REFERENCE TO RELATED APPLICATION(S)

This application claims the benefit of and priority to U.S. Provisional Application Ser. No. 63/623,173, entitled “Asynchronous Artificial Intelligence System” and filed on Jan. 19, 2024, which is expressly incorporated by reference herein in its entirety.

### INTRODUCTION

The present disclosure relates generally to the field of machine learning and artificial intelligence.

Machine learning (ML) and artificial intelligence (AI) based systems may be used for various applications. The model may be trained for a particular purpose or application. Then, input information may be input to the trained model to generate an output. The results of the output may be further provided as feedback to further train the model. In some aspects, the model may be a machine learning model that uses statistical algorithms to perform tasks or provide predictive analytics. Among other examples, AI/ML models may be used for search engines, recommendation systems, and/or creative tools.

### SUMMARY

The following provides a simplified summary of one or more aspects in order to provide a basic understanding of such aspects. The summary is not an extensive overview of all contemplated aspects and neither identifies key or critical elements of all aspects nor delineates the scope of any or all aspects. Its sole purpose is to present some concepts of one or more aspects in a simplified form as a prelude to the more detailed description that is presented later.

The use of artificial intelligence and machine learning models can include centralized models that accumulate and process data from multiple sources. These centralized models may be trained to identify or classify one or more items within a data set. Aspects presented herein provide a system that allows for the coordination of the centralized models to identify or classify one or more items within a data set.

Aspects include an asynchronous artificial intelligence (AAI) system that is configured to receive internal data associated with a customer of the AAI system, wherein the customer is a service provider; search, in an ongoing manner, one or more external data sources that are external from the customer to obtain external data; and send machine learning output to the customer that presents a proposal of a customer action to address a predicted service degradation of the service provider based on the input of the internal data and the external data to an AI or machine learning (AI/ML) model that is trained based on historical data of the customer.

The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a flowchart illustrating a method of an asynchronous artificial intelligence (AAI) system, in accordance with various aspects of the present disclosure.

FIG. 2 is a diagram illustrating an example application for an AAI system, in accordance with various aspects of the present disclosure.

FIG. 3 is a diagram illustrating an example application for an AAI system, in accordance with various aspects of the present disclosure.

FIG. 4 is a block diagram of a computer system on which the disclosed system and method can be implemented, in accordance with various aspects of the present disclosure.

FIG. 5 is a diagram showing an AAI system, in accordance with various aspects of the present disclosure.

### DETAILED DESCRIPTION

Artificial Intelligence (AI) may refer to a set software modules that constantly analyze data and propose actions for successful completion of a task or improving quality of a service. Machine Learning (ML) may refer to a constant improvement of the probability for success by receiving new data and correcting the mathematical and logical models.

Aspects disclosed herein include a system for asynchronous artificial intelligence (AAI), e.g., an AI based system that works (e.g., constantly works) in the background and propose actions proactively without being triggered by the customer. In some aspects, the asynchronous AI system may analyze, historical data, receive feedback from the actions taken, autonomously searching for new data, combine internal data with external data, or perform any combination thereof.

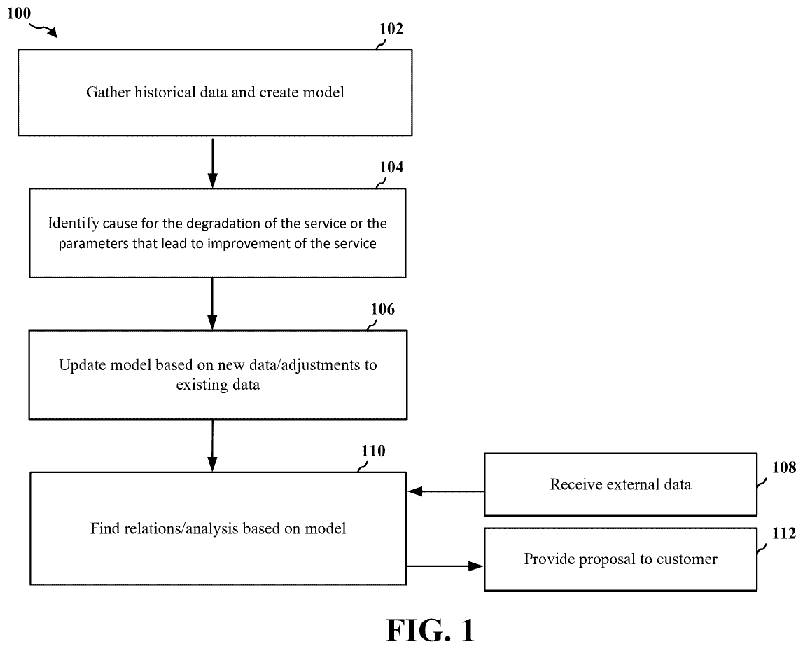

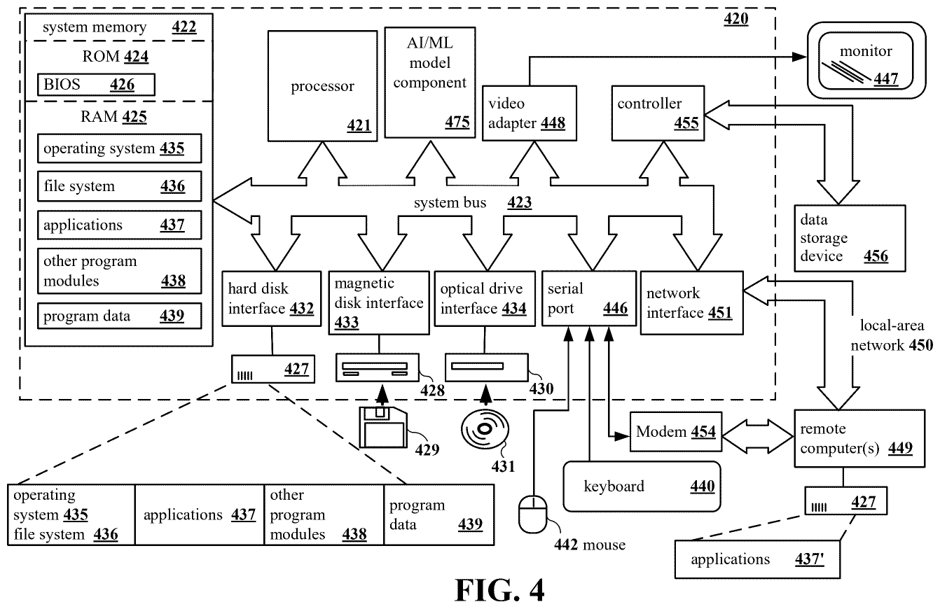

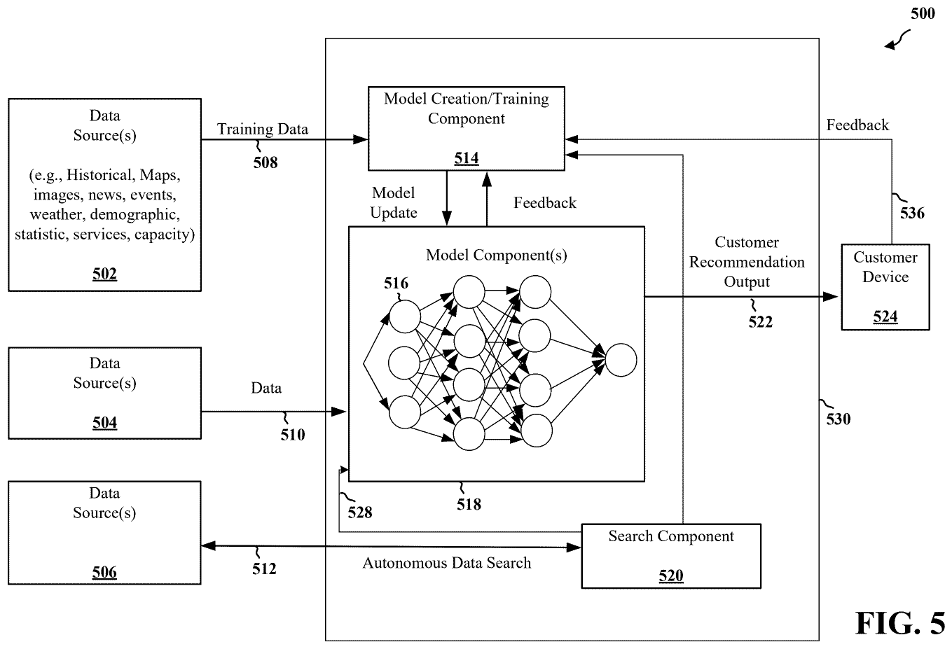

FIG. 1 illustrates an example flowchart 100 showing a method of providing customer recommendations using an asynchronous AI system. The method may be performed by a system that includes aspects described in connection with FIG. 4 or FIG. 5, for example. In some aspects, one or more of the aspects of the flowchart in FIG. 1 may be performed by the AI/ML component 475, which may be configured to perform the aspects described in FIG. 1. These method and apparatus are described and illustrated using blocks, components, circuits, processes, algorithms, which may be referred to as “elements”. Such elements may be implemented using electronic hardware, computer software, or any combination thereof.

By way of example, an element, or any portion of an element, or any combination of elements may be implemented as a “processing system” that includes one or more processors. When multiple processors are implemented, the multiple processors may perform the functions individually or in combination, e.g. may be configured to perform the various functionality described herein. A processor may be referred to as processor circuitry. A memory/memory module may be referred to as memory circuitry. One or more processors in the processing system may execute software. Software, whether referred to as software, firmware, middleware, microcode, hardware description language, etc. means instructions, instruction sets, code, code segments, program code, programs, subprograms, software components, applications, software applications, software packages, routines, subroutines, objects, executables, threads of execution, procedures, functions, or any combination thereof.

The aspects described in connection with FIG. 1 may be implemented in hardware, software, or any combination thereof. If implemented in software, the functions may be stored on or encoded as one or more instructions or code on a computer-readable medium (e.g., which may be referred to as a non-transitory computer-readable medium). Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

FIG. 5 illustrates an example AAI system 500 that includes one or more components configured to perform aspects of the flowchart described in connection with FIG. 1.

As illustrated at 102, the AAI system may gather (e.g., receive or otherwise obtain) the available historical data of a customer. FIG. 1 illustrates an example of a system that may receive data from various difference sources, e.g., illustrated as examples 502, 504, and 506, to illustrate the concept. FIG. 5 illustrates an example in which a model creation and/or training component 514 may receive data 508 from one or more sources, and may use the data to generate, train, and/or refine a model 518. Historical data is an example of data that may be received, at 508. The historical data may be used as input to create an AI/ML model (e.g., illustrated at 518). For example, the AAI system 500 may analyze the data and create a model based on: targets to be achieved, data relations, parameters and/or weights that may also be provided as input to create the model.

Once the model is created, at 104, the AAI system uses the model to find a root cause(s) for an issue, such as a degradation of the service, or the parameters that lead to improvement of the service. These could be single parameters or sets of related parameters.

In course of the time, new data arrives (e.g., as shown at 510 and 512), and the existing data is changed. As the new/adjusted data is received, the AAI constantly analyzes the data and improves the model, as shown at 106. For example, FIG. 5 illustrates that the search component 520 may receive data and provide the data, e.g., as updated data, to the component 514 for additional training and/or refinement of the model 518. As well, in some aspects, data may be input 510 to the model to generate an output 522 of the model. Feedback based on the generated output 522 may be fed back to the component 514 for additional training and/or refinement of the model 518.

For example, in parallel, the AAI system 500 imports external data from various data sources (e.g., 502, 504, and/or 506), as shown at 108 in FIG. 1.

At 110, the AAI system finds relations and performs a what-if analysis using the constantly updated model and the external data. For example, the model 518 may analyze the received data from the various data sources to identify relations in the received data based on the trained model.

As shown at 112, the AAI creates positive scenarios and proposes actions to the customer, e.g., sending an identification, flagging, or highlighting one or more proposed actions to the customer. For example, as shown at 522, the AAI system 500 may output a customer recommendation from the model 518 based on the input data.

As an example, the AAI system 500, e.g., as described in connection with FIG. 1, may analyze the available data and find one or more reasons for degradation of the service at certain points. The “service” may correspond to a service provided by the customer. Therefore, the trained model helps the customer to improve providing its service by identifying reasons for service degradation and/or predicting customer actions to address the degradation. For the identified reasons, the AAI system provides, e.g., outputs, a corresponding action to be taken to address the degradation, as shown at 522. For example, the output may be to a customer device. The output may be provided via a communication interface, such as described in various examples in FIG. 4. The AAI system may also output/provide an indication of (e.g., prediction of) the financial loss if the proposed measure(s) are not taken. In a positive way, the AAI analyzes the behavior of the end user (e.g., that uses a service provided by the customer) and proposes actions for increasing the profit for the customer by extending the capacity or adding services. As described herein, the AAI system 500 is configured to continually collect data (e.g., including both customer data and external data), to refine the model, and to use the model to presented predicted actions to the customer to improve their services in an ongoing, continual manner.

For example, the AAI system continues to acquire and analyze additional data such as geographical maps or satellite images (e.g., the external data 108 in FIG. 1) to discover addresses that could result in potential clients (or users) of the customer. In some aspects, the “customer” described in connection with FIG. 5 may be a business entity, a company, or other entity, that provides a service. The “customer” is referred to as a customer or user of the AAI system, for example. The term “client” is used to describe a user, customer, subscriber, etc., of the customer of the AAI system 500. As examples of data sources 502 and/or 504, statistical and demographics data about a geographic area may be received as inference input to the model 518 to contribute to identifying or defining the services (provided by the customer) that are suitable for the corresponding audience, e.g., potential clients in the geographic region being considered.

In parallel, the AAI system may scan the internet and find events that might influence the either the quality of service or the financial results of the customer, e.g., as another example of external data at 108 in FIG. 1. FIG. 5 illustrates a search component 520 that may be configured to perform an autonomous data search at 512 (e.g., that is performed without a request or trigger from the customer), such as scanning the internet or performing ongoing or periodic searches of one or more data sources 506. For instance, the AAI system 500 may find in the news or other publication, post, or source, that there will be a baseball match between famous teams. The AAI system 500 may take the layout of the network and the network's available capacity, calculate the income and the related expenses, and analyze the received information via the model 518 to output a proposal, at 522, to the customer 524 to install temporary Wi Fi points on the stadium. The proposal might help the customer 524 to receive income either from paid access or from selling advertisement slots to other commercial entities.

As an additional example, a customer 524 may be a power supply company. The AAI system 500 may analyze the available data (e.g., which may be input at 510) and find the most vulnerable points (or points of higher vulnerability) of installation. In the meantime, the AAI system 500 may scan meteorological channels in the Internet, at 512, and find that there will be a hurricane. Based on a combined analysis of the input of data 510 and the search result data at 512, the AAI system 500 may identify the potential occurrence of the hurricane as a potential point of service degradation for the customer 524, and may output, at 522, one or more proposed measures that proved to be successful in the past in order to minimize similar damages. As another example approach based on a weather prognosis, the AAI system 500 may output a proposal for the customer 524 to buy lower priced electricity in advance of a future heat wave or cold weather that the AAI system identifies may affect a power supply company. Such a prediction, and the corresponding output of the recommended action, enables the customer 524 to employ improved advanced planning to address the potential degradation in advance of the weather.

The AAI system 500 connects internal (e.g., that may receive from or associated with a customer 524) and external data sources (e.g., such as the Internet, news services, maps, images, or other sources that are separate from or not associated with the customer), to find relations between events and related services or business actions of the customer. The AAI system 500 used the ongoing receipt of data from internal external sources to improve the model 518 and proactively suggest measures (e.g., recommended customer actions) to the customer 524. In order to minimize the risk of mistakes and misleading the customer 524, the AAI system 500 may start with smaller, or lower-risk, proposals as output at 522. The AAI system 500 may analyze the results (e.g., feedback 536 based on the initial proposals) and gradually build a successful framework. As shown in FIG. 5, the component 514 may continually refine the model 518 based on the feedback and/or ongoing receipt of data information.

The aspects presented herein are applicable to various use cases. As an example to illustrate the concept, a potential application of the AAI system 500 may for be a telecom operator (e.g., as the customer 524) that provides a broadband service to their clients/users. The operator has data for each installation which may include any of the geographic location of the installation, the service provided, and/or the monthly subscription cost for the client. In addition, the operator may have data about the optical cables to the installation points and/or the network capacity of the cables. The data may be input to the AAI system, e.g., as shown at 510, as input of data from the customer (e.g., broadband service operator) as an example of the data source 504.

In the background, the AAI system 500 may constantly monitor one or more of the following parameters: the network capacity (e.g., as an internal source of data), the services provided to the clients (e.g., as an internal source of data), the payments made by the clients of the operator (e.g., as an internal source of data), and/or geographical maps (own GIS or publicly available maps—e.g., as an external source of data), which may be received at 512 and input to the model 518 at 528.

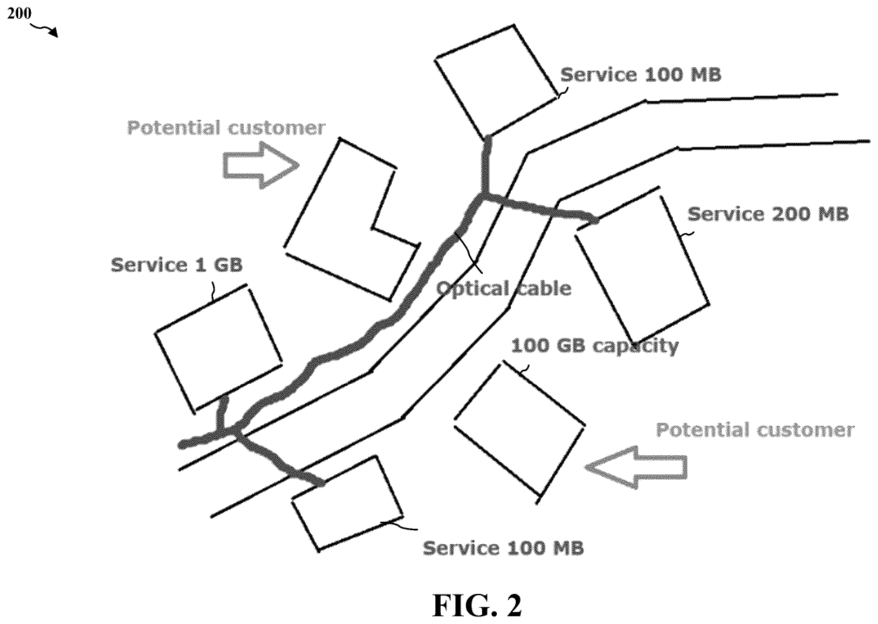

At certain point, the AAI system 500 may identify that there are potential clients along the optical cable root, and there is free capacity for additional installations. The AAI system 500 may output or send notifications to the responsible persons at the customer (e.g., via a customer device 524) and may also provide details of the recommendation. For example, FIG. 2 illustrates a diagram 200 showing an example output of an identification of potential clients for the service provided via the optical cable. The potential client may be a home or business building that may potentially subscribe to the service.

In some aspects, an AI/ML model, e.g., 518, of the AAI system 500 may use machine-learning algorithms, deep-learning algorithms, neural networks, reinforcement learning, regression, boosting, or advanced signal processing methods for receiving content and identifying content of interest for particular users.

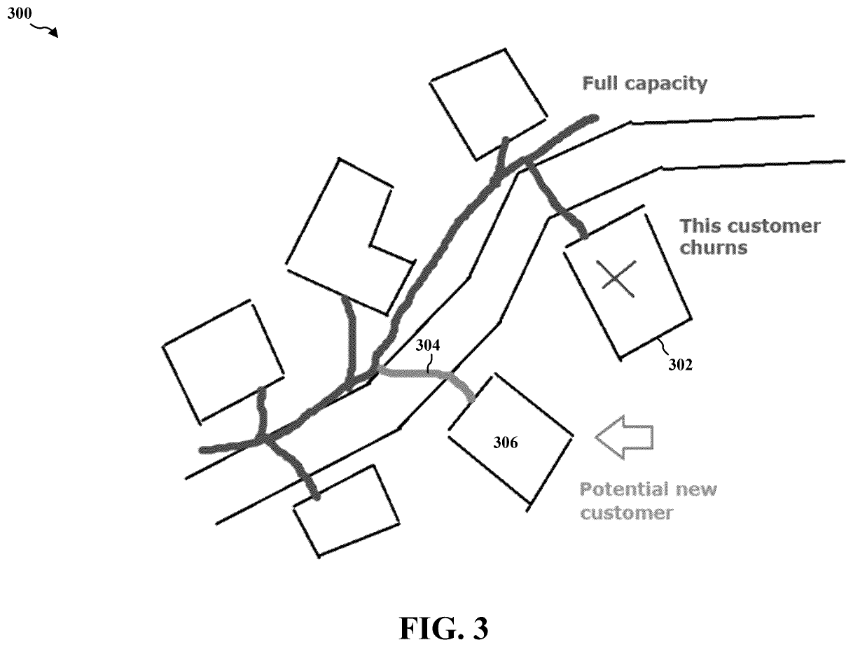

As another example, the network capacity for service via the optical cable may be full without the possibility for additional installations. At a certain point in time, a client may terminate their broadband service by the operator. For example, FIG. 3 illustrates a diagram 300 showing an example in which the customer at building 302 may cancel their service. In response, the AAI system 500 may output an identification of potential customers (e.g., 306) for the service provided via the optical cable 304. Based on receipt of information about the termination (e.g., as data 510) that is input to the model 518, the AAI system 500 identifies that there is (or predicts that there will be) spare capacity and outputs an identification of new potential clients.

As another example, the AAI system 500 may identify that a specific user/client of (e.g., customer) of the broadband service operator does not regularly pay on time. The AAI system 500 analyzes the received data using the model 518 and outputs, at 522, a proposal to the responsible persons at the customer (e.g., one or more customer devices 524) to offer a different service to the client (e.g., which may include a reduced service, and/or a lower cost service). The proposal output at 522 may help the customer (e.g., broadband service provided) to assist the client in stabilizing the cashflow (so that the customer pays regularly) and frees capacity to either connect new customers or to increase the service to the existing customers.

In some aspects, the AAI system 500 (e.g., the model 518 and/or the component 514) may use machine-learning algorithms, deep-learning algorithms, neural networks, reinforcement learning, regression, boosting, or advanced signal processing methods for receiving content, identifying potential problems or improves, and outputting proposals to customers.

Reinforcement learning is a type of machine learning that involves the concept of taking actions in an environment in order to maximize a reward. Reinforcement learning is a machine learning paradigm. Other paradigms include supervised learning and unsupervised learning. Basic reinforcement may be modeled as a Markov decision process (MDP) with a set of environment states and agent states, as well as a set of actions of the agent. A determination may be made about a likelihood of a state transition based on an action and a reward after the transition. The action selection by an agent may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples.

Regression analysis may include statistical analysis to estimate the relationships between a dependent variable (e.g., an outcome variable) and one or more independent variables. Linear regression is an example of a regression analysis. Non-linear regression models may also be used. Regression analysis may include estimating, or determining, relationships of cause between variables in a dataset.

Boosting includes one or more algorithms for reducing variance or bias in supervised learning. Boosting may include iterative learning based on weak classifiers (e.g., that are somewhat correlated with a true classification) with respect to a distribution that is added to a strong classifier (e.g., that is more closely correlated with the true classification) in order to convert weak classifiers to stronger classifiers. The data weights may be readjusted through the process, e.g., related to accuracy.

Among others, examples of machine learning models or neural networks that may be included in the AI/ML model at the central processing system and/or the AI/ML model at each of the remote customer systems include, for example, artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

In some aspects, an example machine learning model, such as an artificial neural network (ANN), that includes an interconnected group of artificial neurons (e.g., neuron models) as nodes (e.g. 516 in the example shown in FIG. 5). Neuron model connections may be modeled as weights, in some aspects. The model 518 may be adapted, e.g., based on external or internal information (e.g., from 502, 504, and/or 506) processed by the model 518. In some aspects, the model may include a non-linear statistical data model and/or a decision making model. Machine learning may model complex relationships between input data and output information, for example.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. The term layer may indicate an operation on input data. Weights, biases, coefficients, and operations may be adjusted in order to achieve an output closer to the target output. Weights and biases are examples of parameters of a trained machine learning model. Different layers of a machine learning model may be trained separately.

A variety of connectivity patterns, e.g., including any of feed-forward networks, hierarchical layers, recurrent architectures, feedback connections, etc., may be included in a machine learning model. Layer connections may be fully connected or locally connected. For a fully connected network, a first layer neuron may communicate an output to each neuron in a second layer. Each neuron in the second layer may receive input from each neuron in the first layer. For a locally connected network, a first layer neuron may be connected to a subset of neurons in the second layer, rather than to each neuron of the second layer. A convolutional network may be locally connected and may be configured with shared connection strengths associated with the inputs for each neuron in the second layer. In a locally connected layer of a network, each neuron in a layer may have the same, or a similar, connectivity pattern, yet having different connection strengths.

A machine learning model, artificial intelligence component, or neural network may be trained, such as training based on supervised learning. During training, the machine learning model may be presented with an input that the model uses to compute to produce an output. The actual output may be compared to a target output, and the difference may be used to adjust parameters (e.g., weights, biases, coefficients, etc.) of the machine learning model in order to provide an output closer to the target output. Before training, the output may not be correct or may be less accurate. A difference between the output and the target output, may be used to adjust weights of a machine learning model to align the output is more closely with the target.

A learning algorithm may calculate a gradient vector for adjustment of the weights. The gradient may indicate an amount by which the difference between the output and the target output would increase or decrease if the weight were adjusted. The weights, biases, or coefficients of the model may be adjusted until an achievable error rate stops decreasing or until the error rate has reached a target level.

FIG. 4 is a block diagram illustrating a general-purpose computer system 420 on which aspects of systems and methods for logic based learning between an AI/ML at a customer instance and a central AI/ML model, e.g., as described in connection with any of FIGS. 1-3 may be implemented in accordance with an example aspect. The computer system 420 can correspond to a physical server(s) on which AAI system is employed, for example.

As shown, the computer system 420 (which may be a personal computer or a server) includes a central processing unit 421, a system memory 422, and a system bus 423 connecting the various system components, including the memory associated with the central processing unit 421. As will be appreciated by those of ordinary skill in the art, the system bus 423 may comprise a bus memory or bus memory controller, a peripheral bus, and a local bus that is able to interact with any other bus architecture. The system memory may include permanent memory (ROM) 424 and random-access memory (RAM) 425. The basic input/output system (BIOS) 426 may store the basic procedures for transfer of information between elements of the computer system 420, such as those at the time of loading the operating system with the use of the ROM 424.

The computer system 420 may also comprise a hard disk 427 for reading and writing data, a magnetic disk drive 428 for reading and writing on removable magnetic disks 429, and an optical drive 430 for reading and writing removable optical disks 431, such as CD-ROM, DVD-ROM and other optical media. The hard disk 427, the magnetic disk drive 428, and the optical drive 430 are connected to the system bus 423 across the hard disk interface 432, the magnetic disk interface 433, and the optical drive interface 434, respectively. The drives and the corresponding computer information media are power-independent modules for storage of computer instructions, data structures, program modules, and other data of the computer system 420.

An example aspect comprises a system that uses a hard disk 427, a removable magnetic disk 429 and a removable optical disk 431 connected to the system bus 423 via the controller 455. It will be understood by those of ordinary skill in the art that any type of media 456 that is able to store data in a form readable by a computer (solid state drives, flash memory cards, digital disks, random-access memory (RAM) and so on) may also be utilized.

The computer system 420 has a file system 436, in which the operating system 435 may be stored, as well as additional program applications 437, other program modules 438, and program data 439. A user of the computer system 420 may enter commands and information using keyboard 440, mouse 442, or any other input device known to those of ordinary skill in the art, such as, but not limited to, a microphone, joystick, game controller, scanner, etc. Such input devices typically plug into the computer system 420 through a serial port 446, which in turn is connected to the system bus, but those of ordinary skill in the art will appreciate that input devices may be also be connected in other ways, such as, without limitation, via a parallel port, a game port, or a universal serial bus (USB). A monitor 447 or other type of display device may also be connected to the system bus 423 across an interface, such as a video adapter 448. In addition to the monitor 447, the personal computer may be equipped with other peripheral output devices (not shown), such as loudspeakers, a printer, etc.

Computer system 420 may operate in a network environment, using a network connection to one or more remote computers 449. The remote computer (or computers) 449 may be local computer workstations or servers comprising most or all of the aforementioned elements in describing the nature of a computer system 420. Other devices may also be present in the computer network, such as, but not limited to, routers, network stations, peer devices or other network nodes.

Network connections can form a local-area computer network (LAN) 450 and a wide-area computer network (WAN). Such networks are used in corporate computer networks and internal company networks, and they generally have access to the Internet. In LAN or WAN networks, the computer system 420 is connected to the local-area network 450 across a network adapter or network interface 451. When networks are used, the computer system 420 may employ a modem 454 or other modules well known to those of ordinary skill in the art that enable communications with a wide-area computer network such as the Internet. The modem 454, which may be an internal or external device, may be connected to the system bus 423 by a serial port 446. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module, element, or component may also be implemented as a combination of the two, with particular functions facilitated by hardware alone, and other functions facilitated by a combination of hardware and software. In particular implementations, at least a portion, and in some cases, all, of a module, element, or component may be executed on one or more processors of a general purpose computer. Accordingly, each module may be realized in a variety of suitable configurations, and should not be limited to any particular implementation or example herein. An element, or any portion of an element, or any combination of elements may be implemented as a “processing system” that includes one or more processors. When multiple processors are implemented, the multiple processors may perform the functions individually or in combination. One or more processors in a processing system may execute stored instructions, which may be referred to as software, firmware, middleware, microcode, hardware description language, or otherwise, e.g., instructions, instruction sets, code, code segments, program code, programs, subprograms, software components, applications, software applications, software packages, routines, subroutines, objects, executables, threads of execution, procedures, functions, or any combination thereof.

In one configuration, the ML/AI model component 475 and/or the computer system 420, and in particular, the file system 436 and/or the processor 421, is configured to perform the aspects of the flowchart in FIG. 1, and/or the aspects described in connection with FIG. 2 or 3.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

As used herein, the phrase “based on” is not a reference to a closed set of information, one or more conditions, one or more factors, or the like. In other words, the phrase “based on X” (where “X” may be information, a condition, a factor, or the like) shall be construed as “based at least on X” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. An asynchronous artificial intelligence (AAI) system comprising:
memory; and
one or more processors configured to:
receive internal data associated with a customer of the AAI system, wherein the customer is a service provider;
search, in an ongoing manner, one or more external data sources that are external from the customer to obtain external data; and
send machine learning output to the customer that presents a proposal of a customer action to address a predicted service degradation of the service provider based on the input of the internal data and the external data to an AI or machine learning (AI/ML) model that is trained based on historical data of the customer.

2. The AAI system of claim 1, wherein the one or more processors are further configured to:
create the AI/ML model based on the historical data of the customer.

3. The AAI system of claim 2, wherein the AI/ML model is created based on one or more of a target to be achieved, a data relation, a parameter of the AI/ML model and/or weights of the AI/ML model.

4. The AAI system of claim 1, wherein the proposal includes one or more of an identification of a cause of the predicted service degradation or an indication or one or more service parameters that are predicted to lead to improvement of the service.

5. The AAI system of claim 1, wherein the one or more processors are further configured to:
find relation in a combination of the internal data and the external data based on the AI/ML model to output the proposal of the customer action.

6. The AAI system of claim 1, wherein the one or more processors are further configured to:
receive feedback on an outcome at the customer based on the customer action output as a proposal; and
refine the AI/ML model based on the feedback.

7. The AAI system of claim 1, wherein the external data includes one or more of internet search results, one or more geographical maps, one or more satellite images, demographic data for a geographic region, statistical data for the geographic region, weather information, a news event, or a news article.

8. The AAI system of claim 7, wherein the internal data includes information obtained at the customer for one or more of capacity for the service, one or more services of the customer, or payment information.

9. The AAI system of claim 1, wherein the customer is a broadband service operator, and wherein the proposal is to offer an adjusted service to a particular customer.

10. The AAI system of claim 1, wherein the customer is a broadband service operator, and wherein the proposal is to install added service points based on a temporary increase in service need based on an event.

11. The AAI system of claim 1, wherein the customer is a broadband service operator, and wherein the proposal is to for one or measures to protect the service during a predicted weather event.

12. The AAI system of claim 1, wherein the customer is a broadband service operator, and wherein the proposal is to offer service to one or more potential clients based on a prediction of available capacity in a geographic region.

13. A method of providing a proposed customer action via an asynchronous artificial intelligence (AAI) system comprising:
receiving internal data associated with a customer of the AAI system, wherein the customer is a service provider;
searching, in an ongoing manner, one or more external data sources that are external from the customer to obtain external data; and
sending machine learning output to the customer that presents a proposal of a customer action to address a predicted service degradation of the service provider based on the input of the internal data and the external data to an AI or machine learning (AI/ML) model that is trained based on historical data of the customer.

14. A non-transitory computer-readable medium storing computer storing computer executable code for providing a proposed customer action via an asynchronous artificial intelligence (AAI) system, the code when executed by one or more processor causes the one or more processor to:
receive internal data associated with a customer of the AAI system, wherein the customer is a service provider;
search, in an ongoing manner, one or more external data sources that are external from the customer to obtain external data; and
send machine learning output to the customer that presents a proposal of a customer action to address a predicted service degradation of the service provider based on the input of the internal data and the external data to an AI or machine learning (AI/ML) model that is trained based on historical data of the customer.
